(19) United States
(12) Patent Application Publication
(10) Pub. No.: US 2013/0180880 A1
(43) Pub. Date: Jul. 18, 2013

(54) VIDEO BOX

(71) Applicant: Marc Finkel, Las Vegas, NV (US)

(72) Inventor: Marc Finkel, Las Vegas, NV (US)

(21) Appl. No.: 13/350,371

(22) Filed: Jan. 13, 2012

(51) Int. Cl. G03B 29/00; B65D 25/00; B65D 85/86

(52) U.S. Cl. 206/573; 206/578

(57) ABSTRACT

A gift box for presenting a gift to a recipient is disclosed. The gift box comprises a bottom portion, a top portion pivotally hinged to the bottom portion, memory, a camera secured to the box and an actuation switch coupled to the camera to activate the camera to record an image of the recipient when the top portion is opened relative to the bottom portion to expose the gift to the recipient, wherein the image is stored in the memory.

### FIELD OF TECHNOLOGY

The present disclosure relates generally to a keepsake box for jewelry, and which includes an audio/video display device to present a pre-recorded message, as well as an audio/video recording device to record a user's reaction when opening the box.

### BACKGROUND

Keepsake, or gift, boxes, such as for jewelry, including rings, earrings, watches bracelets, necklaces or the like are well known. They can be used both to present the keepsake to someone, such as a gift, as well as store the keepsake for later enjoyment. However memories associated with receiving the gift may diminish over time.

Keepsake boxes have been provided which include an audio/video display device and associated circuitry to display a prerecorded message when the particular box is opened. See, for example, Oh, US published patent application no. 2008/0251396, and Lee, US published patent application no. 2007/0295619. However these keepsake boxes do not include any means to record the reaction of the recipient of the box when the box is opened.

### SUMMARY

Features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

### BRIEF DESCRIPTION OF THE FIGURES

FIG. 1 is a perspective view of a keepsake box in accordance with the present invention, with the keepsake box in a closed position;

FIG. 2 is a perspective view of the keepsake box of FIG. 1, with the keepsake box in a closed position;

FIG. 3 is a plan view of an underside of the keepsake box of FIG. 1; and

FIG. 4 is a view of internal circuitry of the keepsake box of FIG. 1.

### DETAILED DESCRIPTION

While this invention is susceptible of embodiments in many different forms, there is shown in the drawings and will herein by described in detail a preferred embodiment of the invention with the understanding that the present disclosure is to be considered as an exemplification of the principles of the invention and is not intended to limit the broad aspect of the invention to the embodiment illustrated.

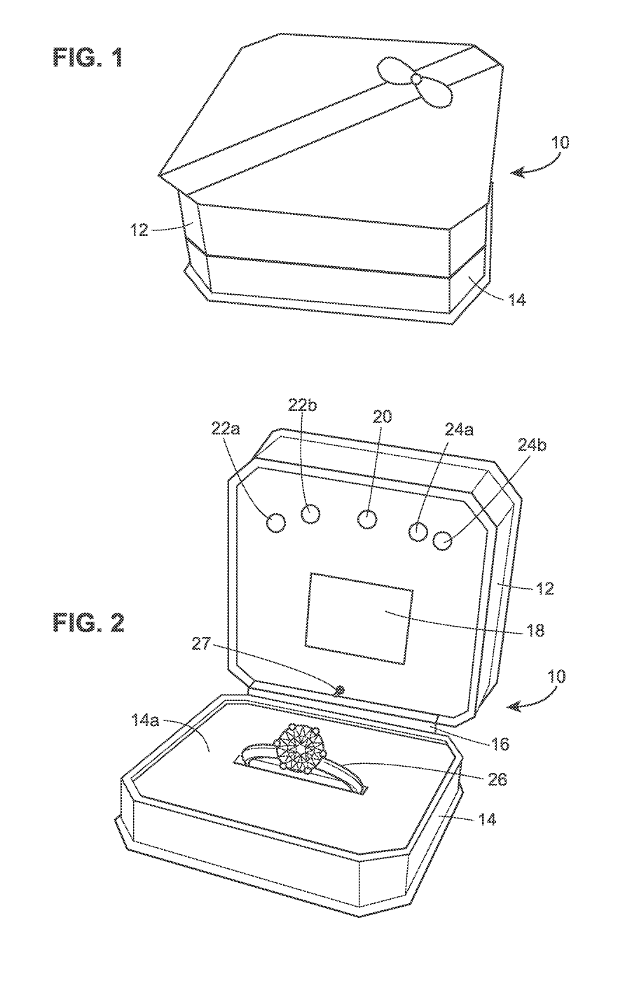

A keepsake box 10 is illustrated in FIGS. 1 and 2. The box 10 may include a top portion 12, a bottom portion 14, pivotally coupled by a hinge 16. A conventional spring clip (not shown) may be provided to maintain the box 10 alternatively in either the open or closed position.

The top portion may include a video display screen 18, such as a 2.4″ (diagonal) display screen and a camera 20, such as a 3.2 megapixel camera. The top portion may further include first and second microphones 22a, 22b, and first and second speakers 24a, 24b. As shown in FIG. 2, a piece of jewelry 26, in the form of a ring, may be supported by an upper surface 14a of the bottom portion 14. An activation switch 27, such as a pushbutton switch, may be disposed in the top portion 12 which changes state when the box 10 is moved between the closed position and the open position, and vice versa.

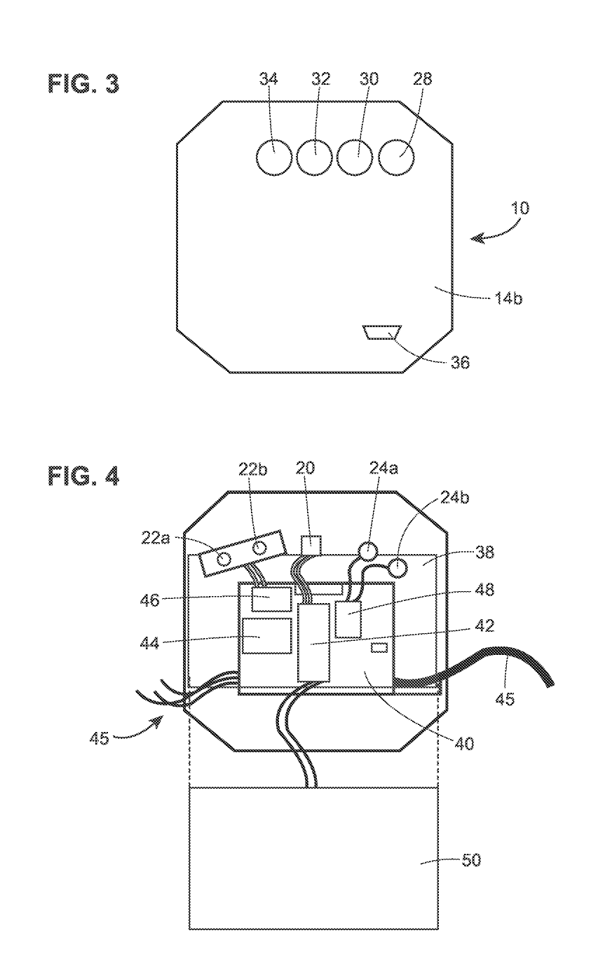

A lower surface 14b of the bottom portion 14 is illustrated in FIG. 3. First through fourth switches 28, 30, 32, 34, may be accessed through the lower surface 14b. A computer port 36, such as a USB port (shown) or memory chip port, may also be accessed through the lower surface 14b.

Circuitry, generally designated 38, mounted on a conventional printed circuit board 40, may include a processing device 42, such as a microprocessor, memory 44, such as flash memory, microphone processing circuitry 46, speaker processing circuitry 48 and a battery 50, such as a rechargeable battery. The battery 50 may be recharged via the computer port 36, as is known.

In accordance with the disclosure, the keepsake box 10 may permit the recording and replay of both a prerecorded message as well as a message recorded at the time the box 10 is presented and opened, both of which are stored in the memory 44.

There are ways to load the prerecorded message in to the memory 44. One is to record the message in a conventional manner to a file and to transfer the file in a conventional manner via the computer port 36 to the memory 44. Another is to record the message directly via the box 10, as discussed below.

As described above, the box 10 may include first through fourth switches, 28, 30, 32, 34. The first through fourth switches 28, 30, 32, 34, may be connected to the printed circuit board via conventional connections 45.

The first switch 28 may be a two position, spring loaded switch, which toggles between a closed position and an open position. The first switch 28 may control whether or not the camera will begin recording when the box 10 is opened (the gift recording), as determined by the actuation switch 27. This permits, inter alia, that once the gift recording is made, the gift recording will not be overridden the next time the box 10 is opened.

The second switch 30 may alternately initiate, and terminate, playback of the gift recording.

The third switch 32 may control the stopping and starting of the recording of the prerecorded message. Pressing the third switch once initiates recording of the prerecorded message. Pressing the third switch a second time terminates recording of the prerecorded message. This process may be continued until an acceptable prerecorded message is obtained, erasing any previously recorded message.

Pressing the fourth switch 34 may alternately initiate, and terminate, playback of the prerecorded message.

In operation, a prerecorded message may be loaded in the memory 44, either via the computer port 36 or by directly recording it using the camera 20 and microphones 22a, 22b, in conjunction with the third switch 32.

The keepsake may then be placed in the box 10 and the first switch 28 is then set to record when the box 10 is opened. When the box is opened, while the recipients reaction is being recorded, the prerecorded message may be displayed, visually as well as audibly. The audio level of the prerecorded message is reduced so as not to adversely affect the recording of the recipients voice.

While a specific embodiment has been illustrated and described, numerous modifications may come to mind without significantly departing from the spirit of the invention, and the scope of protection is only limited by the scope of the accompanying claims.

What is claimed is:

1. A gift box for presenting a gift to a recipient, the gift box comprising:
a bottom portion;
a top portion pivotally hinged to the bottom portion;
memory;
a camera secured to the box; and
an actuation switch coupled to the camera to activate the camera to record an image of the recipient when the top portion is opened relative to the bottom portion to expose the gift to the recipient, wherein the image is stored in the memory.

2. The gift box of claim 1 wherein the camera is a still camera.

3. The gift box of claim 1 wherein the camera is a video camera.

4. The gift box of claim 1 including a display for displaying the image.

5. The gift box of claim 1 wherein the top portion has an underside and the display is disposed on the underside.

6. The gift box of claim 1 including a microphone coupled to the actuation switch to record an audible response of the recipient when the top portion is opened relative to the bottom portion, wherein the audible response is stored in the memory.

7. The gift box of claim 1 including a prerecorded message stored in the memory.

8. The gift box of claim 7, wherein the prerecorded message is played in response to actuation of the actuation switch.

9. The gift box of claim 8, wherein the prerecorded message is a video message.

10. The gift box of claim 9 wherein the video message is a still message,

11. The gift box of claim 7, including a computer port for downloading the prerecorded message to the memory.

12. The gift box of claim 1 including a switch to permit recording of the prerecorded message.

13. A gift box for presenting a gift to a recipient, the gift box comprising:
a bottom portion;
a top portion pivotally hinged to the bottom portion;
memory;
a camera secured to the box;
an actuation switch coupled to the camera to activate the camera to record an image of the recipient when the top portion is opened relative to the bottom portion to expose the gift to the recipient, wherein the image is stored in the memory;
a microphone coupled to the actuation switch to record an audible response of the recipient when the top portion is opened relative to the bottom portion, wherein the audible response is stored in the memory;
a display for displaying the image; and
a speaker for annunciating the audible response.

14. The gift box of claim 13 wherein the top portion has an underside and the display is disposed on the underside.

15. The gift box of claim 13 including a prerecorded message stored in the memory.

16. The gift box of claim 15, wherein the prerecorded message is played in response to actuation of the actuation switch.

17. The gift box of claim 15, wherein the prerecorded message is a video message.

18. The gift box of claim 17 wherein the video message is a still message,

19. The gift box of claim 15, including a computer port for downloading the prerecorded message to the memory.

20. The gift box of claim 13 including a switch to permit recording of the prerecorded message.
